(19) United States
(12) Patent Application Publication
(10) Pub. No.: US 2024/0054671 A1
(43) Pub. Date: Feb. 15, 2024

(54) METHOD AND SYSTEM FOR LEARNED MORPHOLOGY-AWARE INVERSE KINEMATICS

(71) Applicant: Unity Technologies ApS, Copenhagen (DK)

(72) Inventors: Boris Oreshkin, Mont-Royal (CA); Florent Benjamin Bocquelet, Chambéry (FR); Vikram Seetharama Voleti, Kitchener (CA); Louis-Simon Ménard, Montréal (CA)

(21) Appl. No.: 18/233,847

(22) Filed: Aug. 14, 2023

Related U.S. Application Data
(60) Provisional application No. 63/397,557, filed on Aug. 12, 2022.

(51) Int. Cl. G06T 7/70; G06V 10/44

(52) U.S. Cl. CPC G06T 7/70; G06V 10/44; G06T 2207/20044

(57) ABSTRACT

A method of estimating a pose for a custom character is disclosed. A skeleton corresponding to a user-supplied character is received or access. Features of the skeleton of the user-supplied character are computed. A set of betas and a scale value that correspond to a skinned multi-person linear (SMPL) model of the user-supplied skeleton are computed. The pose of the skeleton of the custom character is estimated using the SMPL model.

### CROSS-REFERENCE TO RELATED APPLICATIONS

This application claims the benefit of U.S. Provisional Application No. 63/397,557, filed Aug. 12, 2022, which is incorporated by reference herein in its entirety.

### TECHNICAL FIELD

The subject matter disclosed herein generally relates to the technical field of computer graphics, and in one specific example, to computer systems and methods for digital content creation.

### BACKGROUND

Inverse kinematics (IK) is the problem of estimating 3D positions and rotations of body joints given some end-effector locations. Forward kinematics may use joint parameters to compute a configuration of a kinematic chain; IK may reverse this calculation to determining the joint parameters to achieve a desired configuration. IK is an ill-posed nonlinear problem with multiple solutions. For example, given the 3D location of a right hand of a character, IK may be used to solve for a realistic human pose for the entire character body. This may have many poses which satisfy the constraint of the right-hand location.

IK has been a long-standing problem that has been attempted to be solved for varied applications including robotics and animation. Older methods involve global optimization through analytical methods, or iterative optimization through numerical methods.

IK systems are often rigid with respect to their input character, thus requiring user intervention to be adapted to new skeletons.

### BRIEF DESCRIPTION OF THE DRAWINGS

Features and advantages of example embodiments of the present disclosure will become apparent from the following detailed description, taken in combination with the appended drawings, in which:

FIG. 1 is a schematic illustration of a morphology-aware inverse kinematics system, in accordance with example embodiments;

FIG. 2A is a schematic illustration of a neural network architecture that may be used within a global position decoder and/or an inverse kinematics decoder, in accordance with example embodiments;

FIG. 2B is a schematic illustration of an example neural network architecture, in accordance with example embodiments;

FIG. 3 is a block diagram of an example method of training a SMPL-IS model, in accordance with example embodiments;

FIG. 4 is a block diagram of an artistic workflow pipeline that includes a morphology-aware inverse kinematics SMPL-IK system, in accordance with example embodiments;

FIG. 5 is a flowchart of an example pipeline for pose authoring with a custom humanoid character via SMPL-IK and/or SMPL-IS;

FIG. 6 is a flowchart of an example pipeline for 2D image labeling with an accurate 3D pose;

FIG. 7 is a block diagram illustrating an example software architecture, which may be used in conjunction with various hardware architectures described herein; and

FIG. 8 is a block diagram illustrating components of a machine, according to some example embodiments, configured to read instructions from a machine-readable medium (e.g., a machine-readable storage medium) and perform any one or more of the methodologies discussed herein.

FIG. 9 is a block diagram illustrating a machine learning program, according to some examples.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the disclosed subject matter. It will be evident, however, to those skilled in the art, that various embodiments of the disclosed subject matter may be practiced without these specific details.

In example embodiments, IK is applied in the field of animation when creating a character pose. An animator only needs to provide a partial definition of the target pose via a limited set of positional and angular constraints (i.e., by moving a few joints). A computer tool (e.g., a system having one or more modules) may then be configured to complete the remainder of the pose through an IK model, reducing or minimizing the overhead to the animator.

In example embodiments, especially for humans and/or humanoid characters, the one or more modules are configured to solve IK in the framework of the Skinned Multi-Person Linear Model (SMPL): for example, a realistic 3D human body model parameterized by the body's shape and pose based on skinning and blend shapes. The SMPL model can realistically represent a wide range of human body shapes controlled by shape parameters, as well as natural pose-dependent deformations controlled by pose parameters. With the SMPL model (and derivatives such as DMPL, STAR, SMPL+H, SMPL−X, SMPLify, SMAL, and others), the one or more modules may be configured to interact with different body shapes for the same pose, and vice-versa.

In example embodiments, a method of estimating a pose for a custom character is disclosed. A skeleton corresponding to a user-supplied character is received or access. Features of the skeleton of the user-supplied character are computed. A set of betas and a scale value that correspond to a skinned multi-person linear (SMPL) model of the user-supplied skeleton are computed. The pose of the skeleton of the custom character is estimated using the SMPL model.

The present disclosure includes one or more systems or apparatuses that perform one or more operations or one or more combinations of operations described herein, including data processing systems which perform these operations and computer-readable media having a set of instructions that, when executed by one or more computer processors, cause the one or more computer processors (e.g., of a data processing system) to perform these operations. These operations or combinations of operations include one or more non-routine and/or unconventional operations or combinations of operations, as one-skilled in the art would understand from the descriptions herein.

The systems and methods described herein include one or more components or operations that are non-routine or unconventional individually or when combined with one or more additional components or operations, because, for example, they provide a number of valuable benefits to digital content creators. For example, the systems and methods described herein provide a flexible, learned IK solver (the SMPL-IK system described below) applicable to a wide variety of human morphologies, wherein the learned IK solver may operate on characters defined with the Skinned Multi-Person Linear model (SMPL). The learned IK solver is referred to herein as SMPL-IK. In accordance with an embodiment, and as shown herein, SMPL-IK may be integrated in a real-time 3D digital content creation system to provide novel AI-assisted animation workflows. For example, pose authoring can be made more flexible with SMPL-IK because it allows users to modify gender and body shape while posing a character. Additionally, as shown herein, SMPL-IK may accelerate animation pipelines by allowing users to bootstrap poses from 2D images while allowing for further editing by combining SMPL-IK with pose estimation algorithms (e.g., estimating a 3D pose of a character from a 2D image). Furthermore, there is described herein a system and method (referred to herein as SMPL-IS) which is a SMPL-Inversion mechanism to map arbitrary humanoid characters to the SMPL space, allowing artists to leverage SMPL-IK on custom characters. In addition, there is also described herein a method to infer a best set of effectors that help build a given pose. This Effector Recovery method (described below) helps identify the most useful effectors for a given pose, thereby minimizing the effort in subsequently editing it.

SMPL-IK

Described herein is the SMPL-IK method and system, which is a learned morphology-aware inverse kinematics method and system that accounts for SMPL shape and gender information to compute a full pose of a character, which includes the root joint position and 3D rotations of some or all SMPL joints based on a partially-defined pose, wherein the partially-defined pose is specified by SMPL β-parameters (shape), a gender flag, and positions of only a few joint input effectors (e.g., only a subset of possible effectors for the character, wherein the effectors include input effectors such as positions, rotations, or look-at-targets). The SMPL-IK system includes a neural network which is conditioned using SMPL β-parameters and gender data as model inputs, thus allowing the SMPL-IK system to work with characters that have a variable morphology. This results in an IK model that can operate on the wide range of morphologies incorporated in the expansive dataset used to create the SMPL model itself.

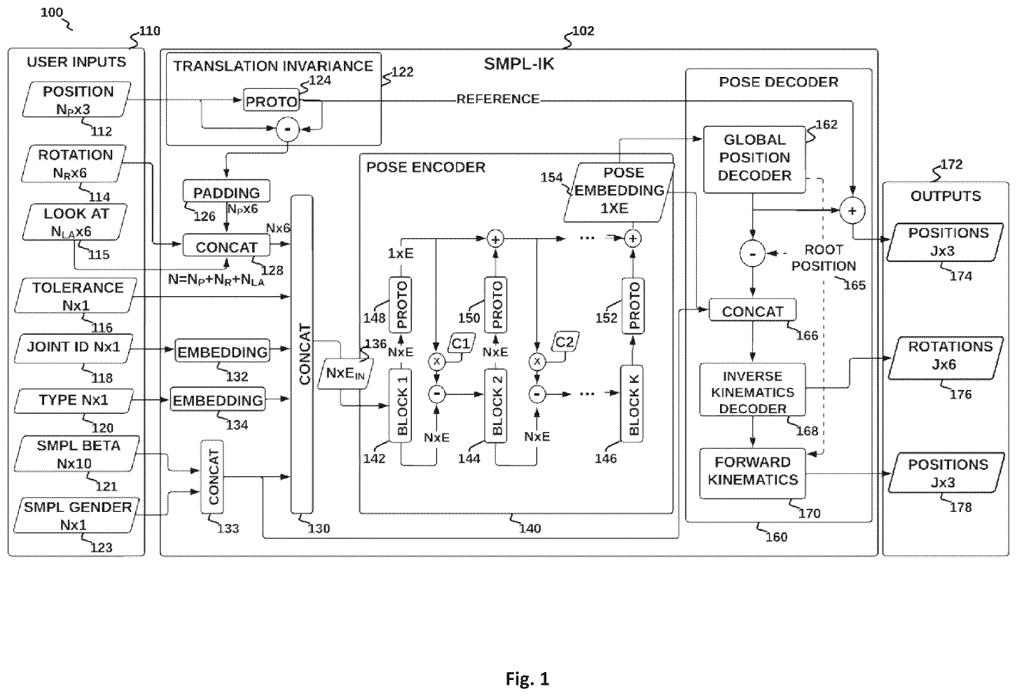

In accordance with an embodiment, the SMPL-IK system (e.g., the neural network therein) takes as input a variable set (e.g., variable type and/or number) of effector positions, or rotations or look-at targets for a character, and performs IK to estimate all the joint locations and rotations for the character using an encoder-decoder architecture (e.g., shown in FIG. 1). Since the variable number of inputs provides a lot of flexibility to the user to choose any set of effectors to manipulate the character's pose, the disclosed system (e.g., the SMPL-IK system) may be highly useful for pose authoring (e.g., editing a pose of a 3D character) within digital content creation software (DCC). In accordance with an embodiment, the SMPL-IK system may be trained on real (e.g., motion-capture data) and/or synthetic 3D data.

In example embodiments, there are multiple advantages of using SMPL β-parameters and gender data as model inputs, including the following: (i) ability to use rich public datasets which are compatible with the SMPL model to train the neural network within the SMPL-IK system (e.g., the large AMASS dataset); (ii) combination of IK pose editing with body shape editing (e.g., an animator can edit both a pose and a body shape of a flexible SMPL-based puppet using the SMPL-IK system described herein); and (iii) training the SMPL-IK in SMPL space (e.g., with SMPL β-parameters and gender data as model inputs) unlocks seamless interface with existing AI algorithms operating in a standardized SMPL space, such as computer vision-based pose estimation backbones.

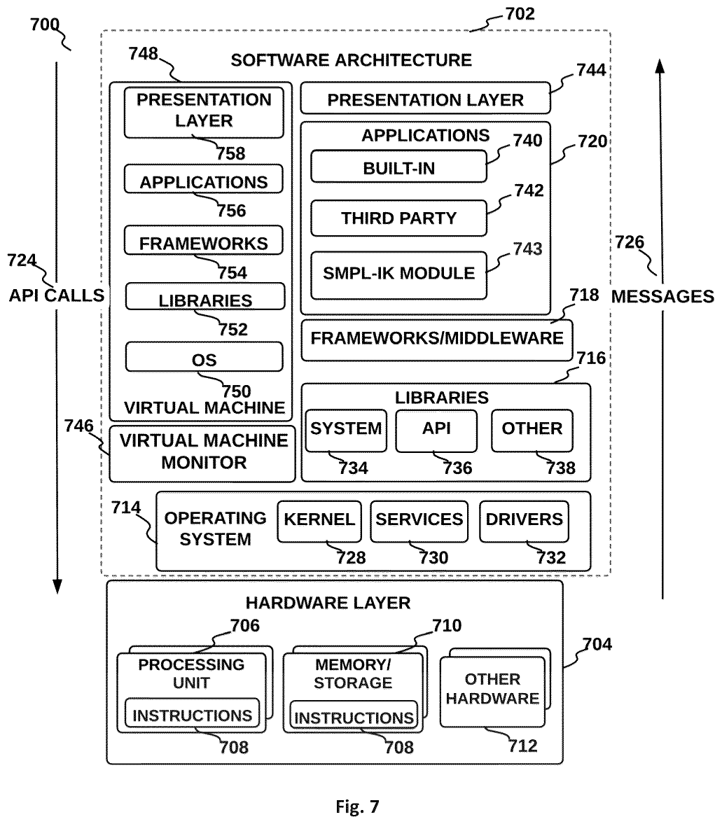

Turning now to the drawings, systems and methods, including non-routine or unconventional components or operations, or combinations of such components or operations, for character posing using the SMPL-IK learned solver in accordance with embodiments of the disclosure are illustrated. In example embodiments, FIG. 1 is a schematic illustration of a morphology-aware inverse kinematics SMPL-IK system 100. In accordance with an embodiment, the SMPL-IK system 100 may be implemented within a SMPL-IK software module 743 as shown in FIG. 7.

The SMPL-IK systems and methods described herein can be applied to any type of character (e.g., to any shape or type of skeleton) including a bipedal human type (e.g., using a SMPL like model), a quadrupedal type (e.g., dog, giraffe, elephant), other odd shaped types (e.g., octopus), and more. In accordance with an embodiment, a skeleton may include a hierarchical set of joints and may also include constraints on the joints (e.g., length of bones between joints, angular constraints, and more), which may provide a basic structure for the skeleton along with body shape values (e.g., such as beta values within a SMPL model). For example, the systems and methods described herein do not use anything specifically limited to a single type of skeleton (e.g., the human body), nor do the systems and methods use any hard-coded constraints that might limit application. As such, the systems and methods described herein can be applied for posing various shaped skeletons such as a dog, or an octopus. In accordance with an embodiment, a character model may include an associated set of effectors, whereby each effector in the set can be used (e.g., by a machine learning system within the SMPL-IK system) to pose a part of the character. In accordance with an embodiment, effectors do not define a pose of a character, they provide constraints for a variable number of joints that are used to satisfy a final pose (e.g., at the output of the SMPL-IK pose prediction system 100). In accordance with an embodiment, there may be a small number of effectors defined as an input to the SMPL-IK pose prediction system 100 (e.g., describing constraints for a small number of associated joints), and whereby the system 100 would determine a pose to satisfy the small number of effector constraints (e.g., the system 100 may find a representation (e.g., a pose embedding described below) for a pose that satisfies the effectors, and then generates a final character pose based on the pose embedding). In accordance with an embodiment, an effector of the set of effectors may be of a type, with the types of effectors including a positional effector, a rotational effector, and a look-at effector as described below:

Positional effector: In accordance with an embodiment, a positional effector includes data describing a position in a world space (e.g., world space coordinates). A positional effector can include subtypes:

Joint effector (positional): In accordance with an embodiment, a joint effector may be a subtype of a positional effector that represents a position of a joint for a character (e.g., such as a desired position for a left foot of bipedal character). In accordance with an embodiment, a joint effector may be a restraint imposed on a joint of a character which forces the joint to occupy the position defined therein.

Reach effector (positional): In accordance with an embodiment, a reach effector is a subtype of a positional effector that represents a desired target position in a world space (e.g., a target ‘future’ position for a joint effector). In accordance with an embodiment, a reach effector may be associated with a specific joint or joint effector, and may indicate a desired position for the joint. In accordance with an embodiment, a reach effector may not be associated with a specific joint or joint effector, but may indicate a desired position for a part of a character (e.g., a desired position for a left hand of a character to grab or point at).

look-at effector: In accordance with an embodiment, a look-at effector is an effector type that includes a 3D position which represents a desired target position in a world space for a joint, wherein the joint is forced (e.g., by the SMPL-IK pose prediction system 100) to orient itself towards the desired target position (e.g., the joint is forced to “look at” the target position). In accordance with an embodiment a look-effector provides an ability to maintain a global orientation of a joint towards a particular global position in a scene (for example, forcing a head of a character to look at a given object or point in a space). The look-at effector is generic in that it allows a model of a neural network architecture within the ML pose prediction system 100 (e.g., the neural network architecture 102 described below with respect to FIG. 1) to align any direction within a joint (e.g., expressed in a local frame of reference), towards a global target location. In accordance with an embodiment, the look-at effector may include data describing the following: a 3D point (e.g., the desired target position), a joint (e.g., a specified joint within a character which must target the desired target position), and/or a specified axis of the joint which must orient itself to the 3D point (e.g., an axis of the joint which is forced by the SMPL-IK pose prediction system to point at the 3D point, wherein the axis may be defined with any arbitrary unit-length vector defining an arbitrary local direction). In accordance with an embodiment, and during a training of the neural network architecture 102, the neural network architecture 102 may be provided with a look-at effector (e.g., including a 3D point in an environment and a specified joint in a character), and may learn to generate a pose of the character wherein the specified joint will additionally satisfy a requirement to look at (e.g., point towards) the 3D point.

Rotational effector: In accordance with an embodiment, a rotational effector may include directional data (e.g., such as a direction vector or an amount and direction of rotation). For example, a directional effector may include a vector specifying a gaze direction, a running velocity, a hand orientation, and the like. In accordance with an embodiment, a rotational effector may include data which describes a local rotation or local direction which is described relative to an internal coordinate system of a character (e.g., a rotation relative to a character rig or relative to a set of joints for the character). In accordance with an embodiment, a rotational effector may include data which describes a global rotation or global direction which is described relative to a coordinate system which is external to the character (e.g., a rotation relative to a coordinate system external to a character rig or external to a set of joints for the character).

While positional, rotational, and look-at types are described above, embodiments of this present disclosure are not limited in this regard. Other effector types may be defined and used within the SMPL-IK pose prediction system 100 without departing from the scope of this disclosure.

In an example embodiment, restraint values for an effector (e.g., a position value for a joint effector, a 3D coordinate value for a look-at effector, a directional value for a rotational effector) may be received from a secondary system and provided to the SMPL-IK pose prediction system 100 to determine a pose which satisfies the restraint. In some example embodiments, the secondary system may include a digital content creation (DCC) software (e.g., wherein a human digital content creation artist operating within an animation pipeline provides constraint values via the DCC software), a procedural animation module, an artificial intelligence animation module, or the like. In other example embodiments, the secondary system may provide effector constraint values in real-time; e.g., received via a joystick, mouse, screen tap or other.

In accordance with an embodiment, an effector within the SMPL-IK pose prediction system 100 includes associated embedded data which represents semantic information for the effector. A semantic meaning (e.g., encoded via an embedding) may be learned by machine learning techniques (e.g., including training and data augmentation as described herein) by the SMPL-IK pose prediction system 100 (e.g., via a neural network therein, including the pose encoder 140 described below with respect to FIG. 1), wherein the semantic meaning may include an intended use of an effector. The embedded data may enable online programmability of a neural network architecture (e.g., the neural network architecture 102 shown in FIG. 1) within the SMPL-IK pose prediction system 100 without requiring a retraining, wherein the online programmability refers to an ability to program the neural network for a new task without a requirement to retrain the neural network. For example, this may include an ability to process a first input that includes a first set of effectors with a first number and type, and/or to process a second input that includes a second set of effectors with a second number and type, wherein the processing of the first input and/or the second input are performed with the neural network without any retraining between the processing. The first set of effectors and the second set of effectors may be provided by an external input (e.g., an input of a user via a joystick, mouse, screen tap or other). For example, a user may specify a position for a hand, then provide a hip position, then provide a look-at position for a face, wherein the SMPL-IK pose prediction system 100 can produce a new output pose based on the variable input over time. In accordance with an embodiment, the embedded data may be appended (e.g., within a vector data structure) to coordinate data, angle data, or other data associated with the effector.

In accordance with an embodiment, during a training of a neural network within the SMPL-IK pose prediction system 100 (e.g., the neural network architecture 102 shown in FIG. 1) and during an operation of a trained version of the neural network, an associated embedding for a joint effector may be used by the neural network within the ML pose prediction system 100 as an identifier (e.g., to determine which specific joint within a character is being processed).

In accordance with an embodiment, the embedded data associated with an effector includes data describing a type for the effector (e.g., wherein types may be described as above: positional, look-at, or directional). In accordance with an embodiment, the embedded type data may be appended to the effector data (e.g., within a vector data structure) so that during training and during operation (e.g., after a training), the neural network within the SMPL-IK pose prediction system 100 (e.g., the neural network architecture 102 shown in FIG. 1) is aware of a type of effector it is processing.

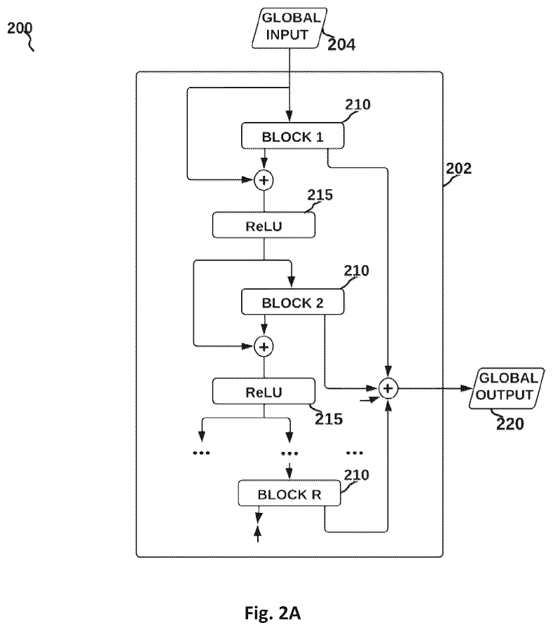

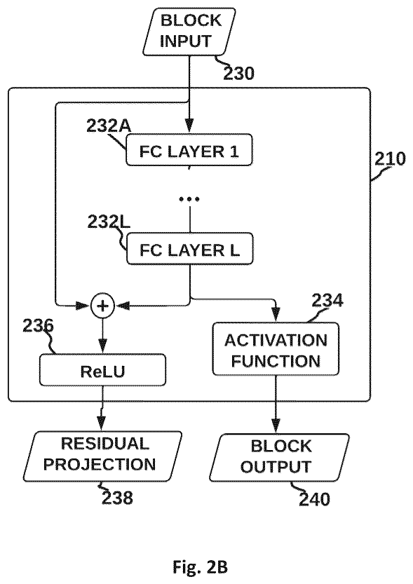

In accordance with an embodiment, the embedded data associated with an effector includes data describing a weight of the effector, wherein the weight describes a relative importance of the effector when compared to other effectors. In accordance with an embodiment, during training and during operation (e.g., after a training), a neural network within the SMPL-IK pose prediction system 100 (e.g., the neural network architecture 102 shown in FIG. 1) may use weight embedded data for an effector to determine a weighting of data associated with the effector (e.g., to determine a weighting of embedded data when using said data within the neural network described in FIG. 1, FIG. 2A, and FIG. 2B). In accordance with an embodiment, as used during training and operation, the weight embedded data provides additional programmability to control a level of importance for each effector.

In accordance with an embodiment, the neural network 102 within the SMPL-IK pose prediction system 100 derives a set of parameters for one or more effectors using machine learning techniques. This may include determining how one or more effectors interact with a full body skeleton using machine learning techniques (e.g., during training). For example, this may include determining constraints (e.g., parameterization) using input data, such as twist or swing limits per joint, etc.

Architecture:

In accordance with an embodiment, and shown in FIG. 1 is a neural network architecture 102 for a SMPL-IK pose prediction system 100. The neural network architecture 102 includes an encoder (e.g., a pose encoder 140) followed by a decoder (e.g., a pose decoder 160) and generates an output prediction 172 from a set of inputs 110. As shown in FIG. 1, the neural network architecture 102 may generate the output 172 in a plurality of steps. In accordance with an embodiment, in a first step of the plurality of steps, a variable number and type of user supplied inputs may be processed, embedded (described below), and combined (e.g., concatenated 130) into a single input 136 (e.g., a single input matrix) for the pose encoder 140. The processing may include a processing for translation invariance 122, padding 126, concatenation 128, and the like. The neural network architecture 102 is flexible in that it accepts a variable number and type of effector for each joint of a character. For example, any joint within an input character may have zero or more associated inputs, and an associated input may include one or more different types (e.g., a first joint may be constrained by user-specified 3D position coordinates and global rotation, while a second joint may be constrained with a look-at effector). In accordance with an embodiment, in a second step of the plurality of steps, the pose encoder 140 may transform the pose specified via effectors (e.g., the input 136) into a single vector encoding of a pose (e.g., a pose embedding 154). In accordance with an embodiment, in a third step of the plurality of steps, the pose decoder 160 may expand the pose embedding 154 into a full pose representation output 172 including local rotation data 176 and global position data 178 for each input joint.

In accordance with an embodiment, the translation invariance 122 may include a re-referencing of input positions relative to a centroid of input positional effectors to achieve translation invariance. The translation invariance 122 may simplify a handling of poses in global space while not relying on a precise reference frame, which can be difficult to define (e.g., for heterogeneous MOCAP sources).

In accordance with an embodiment, the neural network architecture 102 does not require input to follow any specific scheme or that it be fully-specified. Instead, the neural network architecture 102 allows for complete flexibility of defining a character pose by accepting a variable number of inputs of different types. Accordingly, the neural network architecture 102 accepts any combination of input 110 that includes position effectors (3D coordinates), rotation effectors (with any 6DoF representation) and look-at effectors (3D coordinates). In accordance with an embodiment, and shown in FIG. 1, an input effector may include data for position 112 and rotation 114. In accordance with an embodiment, for mathematical convenience, input rotation data 114 may be in a 6 degree of freedom (6DoF) format that is described with six values. In accordance with an embodiment, input position data 112 (e.g., 3D position or look-at coordinates) may be padded (e.g., by adding 3 zero values at operation 126) so that the input position data and the input rotation data 114 are the same length when provided to the pose encoder 140. In accordance with another embodiment, the Look-at input data 115 may be input as an angle with 6 degrees of freedom. In accordance with an embodiment, each effector may be further characterized by tolerance data 116, joint ID 118, and type 120. Tolerance may be a positive floating point value. A smaller tolerance value implies that an effector value has to be more strictly reproduced in a reconstructed output pose (e.g., within the output 172). Joint ID for an effector may be a value (e.g., an integer) indicating which joint is affected by the effector. Effector type may be a value (e.g., an integer) indicating a positional, rotational, or look-at effector (e.g., for positional effector type=‘0’, for rotational effector type=‘1’, and for rotational effector type=‘2’). In accordance with an embodiment, categorical variables (type 120 and joint ID 118) may be embedded into a continuous vector and may also be concatenated with the effector data (position 112 or rotation 114), resulting in an input 136 to the pose encoder 140 being an matrix (e.g., a matrix with size N×Eᵢₙ) with a number of rows (e.g., N rows as shown in FIG. 1) corresponding to a number of input effectors and a number of columns (e.g., Eᵢₙ columns as shown in FIG. 1) corresponding to a combined dimension (e.g., an embedding dimensionality) of all categorical variable embeddings plus 6 DoF effector input dimensions (e.g., either padded position data 112 or rotation data 114). In accordance with an embodiment, the inputs 110 may be entered as batches.

In accordance with an embodiment, the input 110 may include SMPL beta shape parameters 121 and SMPL gender data 123 (e.g., a gender flag value which may include male, female, other, or more genders associated with a character morphology). The SMPL beta 121 and gender data 123 may be concatenated (13 and 133) into the input 136 of the pose encoder 140. The SMPL beta 121 and gender data 123 allows the network 102 to learn inverse kinematic posing relative to a body type and shape for characters defined with a SMPL model.

In accordance with an embodiment, the pose encoder 140 may be a multi-stage residual neural network with residual links of forward and backward types interleaved with prototype layers (148, 150, and 152) of the forward links. In accordance with an embodiment, the pose encoder may apply a machine-learned model based on a fully-connected residual neural network architecture depicted in FIG. 1 (e.g., within the pose encoder 140) and FIG. 2B. In accordance with an embodiment, a prototype layer may be defined as a mean over the leading (effector) dimension of its input. Each stage of the pose encoder 140 corresponds to one residual block. An example structure within a block is described below with respect to FIG. 2B. The residual links may provide several benefits, including: (i) improving gradient flow and increasing a network depth and (ii) achieving an interaction of encodings of individual joints with an encoding of an entire pose created at each encoder stage.

In accordance with an embodiment, as can be seen in FIG. 1, a forward encoding of individual effectors is collapsed into a representation of a complete pose 154 via prototype layers. The representation of a complete pose 154 may be accumulated across a plurality of residual blocks (142, 144, 146) to form a final pose representation 154 as an output of the pose encoder 140. In accordance with an embodiment, constant factors C1 and C2 may serve a purpose of aligning scales of a residual link from a block (e.g., 238 from FIG. 2B) and a global prototype representation of a pose (e.g., 154).

Decoder

In accordance with embodiment, the pose decoder 160 may include two separate modules, both of which may be configured as a fully-connected residual (FCR) neural network architecture (e.g., as depicted in FIG. 2A and FIG. 2B and described below). In accordance with an embodiment, a first module 162 of the two modules may be a global position decoder (GPD), wherein the GPD 162 predicts the internal pose representation 154 generated by the pose encoder 140 directly into an unconstrained prediction of 3D joint positions. The prediction by the global position decoder 162 may be generated by applying a machine learned model based on a fully-connected residual neural network architecture depicted in FIG. 2A and FIG. 2B. In accordance with an embodiment, the output joint positions from the GPD 162 may form a draft pose, in which bone constraints are not necessarily respected. In accordance with an embodiment, a second module 168 of the two modules may be an inverse kinematics decoder (IKD), wherein the inverse kinematics decoder 168 predicts internal geometric parameters (e.g., local rotation angles or joint rotations 176) of the skeleton kinematic system. The prediction by the inverse kinematics decoder 168 may be generated by applying a machine learned model based on a fully-connected residual neural network architecture (e.g., as depicted in FIG. 2A and FIG. 2B). In accordance with an embodiment, the inverse kinematic decoder 168 accepts a concatenation of (i) the pose embedding 154 generated by the pose encoder 140 and (ii) the (unconstrained) joint position predictions generated by the global position decoder 162. In accordance with an embodiment. The inverse kinematic decoder 168 predicts the local rotations 176 of the skeleton joints that, when subjected to predefined skeleton kinematic equations, generate feasible coordinates of all joints.

Global Position Decoder: GPD

In accordance with an embodiment, based on the GPD 162 producing joint position predictions without relying on skeleton constraints, the predictions may not respect skeleton topology and may not be physically feasible. The purpose of the GPD 162 module may be two-fold. First, the task of predicting unconstrained joint positions may provide a task for generating a meaningful pose embedding. Second, the GPD module 162 may generate a reference point for the inverse kinematics decoder 168.

In accordance with an embodiment, the inverse kinematics decoder module 168 generates local joint rotations 176 based on positions defined in global space. In order for the IKD 168 to provide correct rotations, an origin of the kinematic chain in world space must be provided to the IKD 168, and the output of the GPD may 162 provide this data.

Inverse Kinematics Decoder (IKD)

In accordance with an embodiment, the IKD 168 may accept a concatenation of (i) the pose embedding 154 generated by the pose encoder 140 and (ii) the predicted joint positions (e.g., a pose draft) predicted by the GPD module 162. In accordance with an embodiment, the IKD 168 may predict (e.g., using the concatenated input) the local rotation angles 176 of each joint. In accordance with an embodiment, the predicted local rotation angles 176 may also be processed via a forward kinematics pass 170, which generates a global (e.g., and physically feasible) coordinates 178 of skeletal joints and global joint rotations. The forward kinematics pass is further described in more detail below.

Forward Kinematics Pass

In accordance with an embodiment, the forward kinematics pass 170 operates on the output of the IKD 168 and translates the local joint rotations 176 and a global root position 165 into global joint coordinates 178. The global root position 165 may be data describing a position of a joint defined as a root joint (e.g., within the input 110) which may provide a reference point (e.g., an origin) for other joint positions within the input. In accordance with an embodiment, the global root position 165 may be data describing a center of coordinates for the skeleton. In accordance with an embodiment, the translation operation of the forward kinematics pass 170 may be described by two matrices for each joint j, including an offset matrix and a rotation matrix, wherein the offset matrix of joint j provides displacements of the joint with respect to its parent joint along coordinates x, y, z when a rotation of joint j is zero. In accordance with an embodiment, the translation operation may use skeleton kinematic equations. In accordance with an embodiment, the offset matrix may be a fixed non-learnable matrix that describes bone length constraints for a skeleton. In accordance with an embodiment, the rotation matrix may be represented using Euler angles. However, in another embodiment, a more robust representation based on 6 element vectors predicted by the IKD module 168 may be used.

In accordance with an embodiment, the forward kinematics pass 170 takes the global root position 165 and rotation matrices of a plurality of joints as output by the IKD module 168 and generates a global rotation and global position 178 of a joint of the plurality of joints (e.g., by following a tree recursion from a parent joint of the joint).

In accordance with an embodiment, a global position and rotation matrix output for a joint (e.g., the output 176 and 178 of the forward kinematics pass 170) may be a complete 6DOF prediction of the joint, including both global position and global rotation of the joint with respect to a center of coordinates for the skeleton.

In accordance with an embodiment, and shown in FIG. 2A is a schematic diagram of a neural network architecture 202 which may be used within the global position decoder 162 and/or the inverse kinematics decoder 168. In accordance with an embodiment, the neural network architecture 202 has a fully connected residual neural network topology consisting of a plurality of fully connected blocks 210 connected using residual connections. In accordance with an embodiment, a block 210 may have a layer norm at the input and a fork at the output. A first output of the fork may produce a contribution to a global output 220 of the neural network architecture 202. A second output of the fork may contribute to a residual connection to a next block 210 (e.g., wherein the residual connection may additionally be processed by a non-linear rectifier function 215 (e.g., a ReLU non-linearity)). As shown in FIG. 2A, there may be any number of layers consisting of a block 210, an activation function 215, and a residual connection. While FIG. 2A provides an example neural network architecture, other architectures may be used without departing form the scope of this disclosure.

In accordance with an embodiment, FIG. 2B shows an example neural network architecture within a block 210. In accordance with an embodiment, an input 230 to the block 210 may pass through a plurality of fully connected layers 232A, 232L and more (collectively 232). In accordance with an embodiment, an output from a final layer 232L may pass through an activation function 234 to produce a block output 240. The activation function 234 may be linear or non-linear. In accordance with an embodiment, a residual projection 238 may be created by combining an output from the final layer 232L with the block input 230 and processing the combination with an activation function 236. The activation function may be linear or non-linear (e.g., a ReLU activation function).

Losses within the Neural Network Architecture 102

In accordance with an embodiment, three loss types may be used during a training of the neural network architecture 102 in a multi-task fashion. Individual loss terms may be combined additively (e.g., with loss weight factors for each) into a total loss term. The loss weight factors may be chosen to make sure that magnitudes of different loss terms have a same order of magnitude. A loss function combining rotation and position error terms via randomized weights based on randomly generated effector tolerance levels may be used.

In accordance with an embodiment, an L2 loss may be used as a loss type to penalize errors of 3D position predictions. The L2 loss may be defined as a mean squared error between a prediction and ground truth. In accordance with an embodiment, the L2 loss may be used to supervise output of the GPD module 162 (e.g., predicted joint positions 164) by directly driving a learning process of GPD. In accordance with another embodiment, the L2 loss may be used to supervise the position output of the forward kinematics pass 170 by indirectly driving a training of the IKD module 168, wherein the IKD module 168 learns to produce local rotation angles that result in joint position predictions with small L2 loss after IKD outputs are subjected to the forward kinematics pass 170.

In accordance with an embodiment, a geodesic loss may be used as a loss type to penalize errors in rotational output of the neural network architecture 102. Geodesic loss may represent the smallest arc (in radians) to go from one rotation to another over a surface of a sphere. The geodesic loss may be defined for a ground truth rotation matrix and its prediction. The geodesic loss may be used to supervise the rotation output 176 of the IKD module 168. The geodesic loss may directly drive a learning of the IKD module 168 by penalizing deviations with respect to a ground truth of local rotations of all joints.

In accordance with an embodiment, a combination of L2 loss and geodesic loss used when training the neural network architecture 102 may provide a benefit of allowing the neural network architecture 102 to learn a high-quality pose representation (e.g., as an output 172). The combination of L2 loss and geodesic loss may be particularly beneficial for the neural network architecture 102 when reconstructing a partially specified pose, wherein multiple reconstructions may be plausible. Using the combination of L2 loss and geodesic loss may help to train the neural network architecture 102 to simultaneously reconstruct plausible joint positions and plausible joint rotations. In accordance with an embodiment, the combined training of the neural network architecture 102 on L2 loss and Geodesic loss may result in a synergistic effect, wherein the architecture 102 model trained on both L2 loss and geodesic loss generalizes better on both losses than a model trained only on one of the loss terms.

In accordance with an embodiment, a look-at loss may be used as a loss type, wherein the look-at loss is associated with look-at effector. In accordance with an embodiment, the look-at loss drives a learning of the IKD module 168 by penalizing deviations of global directions computed after the forward kinematics pass 170 with respect to a ground truth of global directions.

Training

In accordance with an embodiment, each stage of all or a subset of stages of a SMPL-IK pose prediction system 100 is a fully-connected neural network trained for a task as described above. In accordance with an embodiment, the training for the task may include performing data augmentation on input data, and designing training criterion to improve results of the SMPL-IK pose prediction system 100. In accordance with an embodiment, the training methodology described below includes a plurality of techniques to (i) regularize model training via data augmentation, (ii) teach the model to deal with incomplete and missing inputs and (iii) effectively combine loss terms for multi-task training. The data augmentation and the designing of training criterion is described below.

In accordance with an embodiment, a machine learning training process for the SMPL-IK pose prediction system 100 requires as input a plurality of plausible poses for a type of character (including different morphologies for the type via the SMPL beta parameters 121 and the SMPL gender data 123). In accordance with an embodiment, the plurality of plausible poses may be in the form of an animation clip (e.g., video clip). The input animation clips may be obtained from any existing animation clip repository (e.g., online video clips, proprietary animation clips, etc.), and may be generated specifically for the training (e.g., using motion capture).

In accordance with an embodiment, a SMPL-IK pose prediction system 100 is trained for a type of character (e.g., requiring at least one ML pose prediction system 100 for posing per type of character). For example, there may be a SMPL-IK pose prediction system 100 trained for human type characters, another machine learning (ML) pose prediction system 100 for other animal shaped types which use a similar data structure that includes beta shape parameters (e.g., such as SMAL). The plurality of input poses to train an ML pose prediction system 100 can include any animation clips that include the type of character associated with the ML pose prediction system 100. For example, a SMPL-IK pose prediction system 100 for human posing would require that the SMPL-IK pose prediction system 100 is trained using animation clips of human motion; whereas, an ML pose prediction system 100 for octopus posing would require that the ML pose prediction system 100 is trained using animation clips of octopus motion.

In accordance with an embodiment, a SMPL-IK pose prediction system 100 may be trained for a domain specific context that includes specific motions associated with the context, including boxing, climbing, sword fighting, and the like. A SMPL-IK pose prediction system 100 may be trained for a specific domain context by using input animations for training of the SMPL-IK pose prediction system 100 that includes animations specific to the domain context. For example, training a SMPL-IK pose prediction system 100 for predicting fighting poses should include using a plurality of input fighting animation sequences.

Data Augmentation

In accordance with an embodiment, data augmentation may be used to artificially augment a size of an input training set (e.g., the plurality of input poses), the augmenting providing for an almost infinite motion data input. During training of an SMPL-IK pose prediction system 100, the data augmentation may include randomly translating and randomly rotating character poses in the plurality of input poses. The random translations may be performed in any direction. The addition of random translations of input poses may increase robustness of the SMPL-IK pose prediction system 100 model by providing a greater range of input data. Furthermore, the addition of random translations can increase the possible applications of the SMPL-IK pose prediction system 100 along with increasing the output quality of the SMPL-IK pose prediction system 100 when posing a character. For example, the addition of random translations allows for the SMPL-IK pose prediction system 100 to generate automatic body translation while generating a pose using a hierarchy of neural networks as described herein. For example, the SMPL-IK pose prediction system 100 may generate a translation of a character in addition to providing a pose for the character in order to more closely match inputs (e.g., input effectors) to the generated output pose, since some generated poses may look more natural if accompanied by an additional translation. As a further example, consider a human character that includes input effectors describing position for the hands and feet, the addition of random translations during training will allow the SMPL-IK pose prediction system 100 to predict a natural position of the character body in a world space from the input effectors of the hands and feet position. In accordance with an embodiment, the random rotations may only be performed around a vertical axis, as character poses are typically highly dependent on gravity. The addition of random rotation in input data is also important to train an SMPL-IK pose prediction system 100 to learn automatic full or partial body rotation that may not be present in the original input data. Furthermore, the addition of random rotations also allows for the SMPL-IK pose prediction system 100 to generate automatic body rotation while generating a pose using a hierarchy of neural networks as described herein. For example, the SMPL-IK pose prediction system 100 may generate a rotation of a character in addition to providing a pose for the character in order to more closely match inputs (e.g., input effectors) to the generated output pose, since some generated poses may look more natural if accompanied by an additional rotation.

In accordance with an embodiment, the data augmentation may include augmentation based on selecting a plurality of different subsets of effectors as inputs (e.g. a first combination of hips and hands, a second combination could be head and feet, and the like). This leads to exponential growth in a number of unique training samples in a training dataset. The above described data augmentation, including a selecting of a plurality of different subsets of effectors as inputs, is possible with the network system because, as described here, the network system is configured to process semantic data of a variable number and type of input effectors. In example embodiments, the SMPL-IK pose prediction system 100 model is not trained for a fixed number and type of inputs; instead, it is configured to handle any number of input effectors (and/or combinations of different effector types), each of which may have its own semantic meaning.

In accordance with an embodiment, the data augmentation may include augmentation based on a selecting of a plurality of different number of input effectors during training. For example, during training, the network may be forced to make predictions for all joints (e.g., for all joints in a character rig) based on any arbitrary subset of effector inputs. This can lead to a linear increase in a number of unique configurations of effectors. The above described data augmentation including a selecting of a plurality of different number of input effectors is possible with the network system because, as described here, the network system is configured to process semantic data of a variable number and type of input effectors.

In accordance with an embodiment, the data augmentation may include augmentation based on forcing a same encoder network to process random combinations of effector types during a training. Accordingly, a same encoder, with a same input may learn (e.g., during a training) to process both angular and positional measurements, increasing a flexibility of the trained network. For example, during a training, for any given sample, the network can be forced to predict all joints (e.g., for all joints in a character rig) based on a first combination of effector types (e.g., 3 joint positional effectors and 4 look-at effectors). In addition, for another sample, the network can be forced to predict all joints (e.g., for all joints in a character rig) based on a second combination of effector types (e.g., 10 joint positional effectors and 5 look-at effectors). The above described data augmentation including a processing of random combinations of effector types is possible with the network system because, as described here, the network system is configured to process semantic data of a variable number and type of input effectors.

In accordance with an embodiment, the data augmentation may include augmentation based on forcing a same encoder network to process input samples while randomly choosing a weight (e.g., importance level) for each effector. This results in an exponential growth of a number of unique input samples during training.

In accordance with an embodiment, the data augmentation may include augmentation based on adding random noise to coordinates and/or angles within each effector during a training. In accordance with an embodiment, a variance of the added noise during training may be configured so that it is synchronous with a weight (e.g., importance level) of an effector. This augmentation specifically forces the network to learn to respect certain effectors (e.g., effectors with a high weight) more than others (e.g., effectors with a low weight), on top of providing data augmentation. In accordance with an embodiment, data augmentation and training with the addition of random noise may have applications for processing results of monocular pose estimation, wherein each joint detection provided by a lower level pose estimation routine is accompanied with a measure of confidence.

In accordance with an embodiment, the data augmentation may be done on the fly during training to provide near infinite and variable input data for training (e.g., as opposed to pre-computing the data augmentation before training which only provides a fixed amount of input data). The on the fly data augmentation may also provide for a more variable input data set for training when compared to pre-computed data augmentation, by for example eliminating a possibility of using the same input data point (e.g., an input pose) twice since new input data is randomly generated when needed. For example, consider an original input data set of 1,000 poses, during a training, the SMPL-IK pose prediction system 100 may generate additional input data via random translations and rotations as needed for training (e.g., based on a training metric). The generated additional input data during training may amount to 50,000 poses, 500,000 poses, 5 million poses or more and may be adjusted during training (e.g., depending on the training metric). This is in contrast to pre-computed data augmentation where data augmentation is computed before training and is fixed during training regardless of any training metric.

SMPL-IS

There are times where a custom character (e.g., bone structure and body morphology) needs to be converted to a comparable SMPL model. Described herein is the SMPL inversion shape (SMPL-IS) method to connect a custom user character with the standardized SMPL space. In accordance with an embodiment, SMPL-IS maps an arbitrary skeleton onto a comparable SMPL model approximation by learning a mapping from skeleton features to the corresponding SMPL β-parameters (essentially solving the inverse shape problem). In accordance with one embodiment shown here, SMPL-IS may include soft k-nearest neighbors in the space of β-parameters and key joint positions to estimate the β-parameters that best match those of the custom character. The detailed model description is provided below.

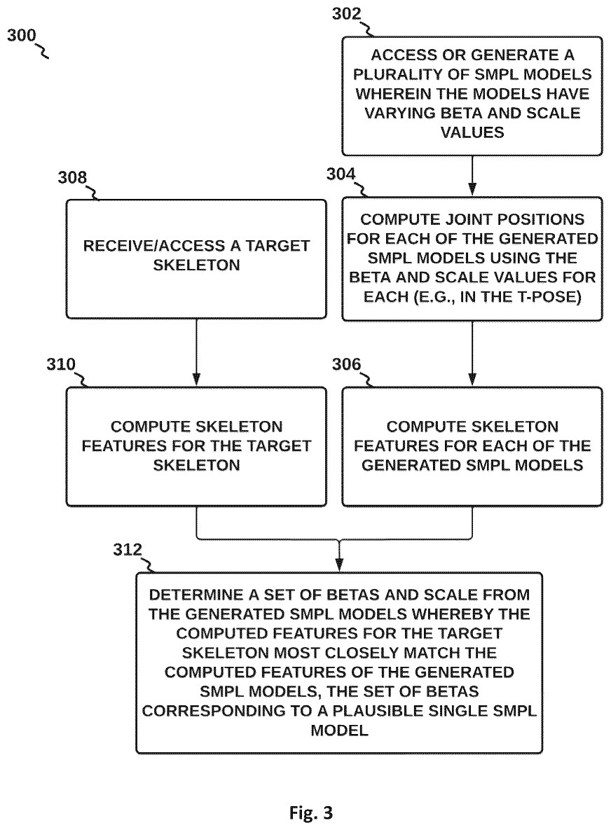

In accordance with an embodiment, and shown in FIG. 3, is a method 300 for SMPL-IS. In various embodiments, some of the operations shown in FIG. 3 may be performed concurrently, in a different order than shown, or may be omitted. In some embodiments, the method 300 works optimally when the SMPL model implements the following forward equation (1)

p=SMPL(β,θ)

Wherein equation (1) maps shape parameters β and pose angles θ into joint positions p (e.g., wherein p is a vector). The shape parameters β are typically represented by a vector with a plurality of values (e.g., there are 10β parameters in a typical SMPL model). The pose angles θ are typically represented by a matrix with a plurality of values for 3D joint angles and a 3D root joint location (e.g., there are 24θ values wherein each θ value is a 3D vector for angle within a typical SMPL model). The SMPL-IS system is a model (e.g., a machine learning model) that learns the inverse shape model of equation 1; namely using an input of skeleton features from a provided user skeleton to infer a set of β parameters that best match the provided user skeleton. A large dataset that contain multiple tuples (pᵢ, βᵢ, θᵢ) can be used to train the SMPL-IS model by using pairs of skeleton features fᵢ extracted from the tuple (pᵢ, θᵢ) along with corresponding supervision samples βᵢ. For example, the SMPL-IS model learns the following equation (2) to infer beta values P from skeleton features f:

\hat{β}=SMPL−IS(f).

Taking this into account, the SMPL-IS model may be trained as described below and shown in FIG. 3. In accordance with an embodiment, at operation 302 of the method 300, a large plurality of SMPL models is accessed, wherein the large plurality includes models that have varying β values that include varying scale values. The large plurality of SMPL models may be generated by randomly generating a large sample of tuples of joint position and beta values (e.g., (pᵢ, βᵢ)) with the βᵢ values having a distribution and scale over a range. To create the distribution, the βᵢ values may be randomly generated (e.g., where each βᵢ may include a plurality of parameter values (e.g., 10 values for a single body SMPL model)). For example, each βᵢ may be formed with a random number ϵi and a scale factor si, wherein each βᵢ=[ϵi, si]. In accordance with an embodiment, ϵi may be from the set of real numbers (e.g., 10 real numbers for a SMPL model) and which may be sampled from a uniform distribution (e.g., from a uniform function U (−5, 5)) and which may be scaled with the scale value si sampled from a range (e.g., from a uniform function U (0.2, 2)). The scale value si allows for the SMPL-IS model to accurately account for a user supplied character having a smaller or larger overall scale when compared to a SMPL model. Similarly, the varying β values allow the SMPL-IS model to accurately represent a large variety of different body types. In practice, a specific number for the large plurality may be determined by balancing accuracy of the SMPL-IS model with the resources (e.g., time and/or computing resources) to train the model. Larger numbers of accessed (e.g., generated) models with varying β and scale values may lead to a more accurate SMPL-IS model but require more computation resources, and vice-versa when compared to a smaller number of accessed models.

In accordance with an embodiment, at operation 304 of the method 300, the SMPL forward equation (1) is used to compute joint positions pᵢ for each of the generated SMPL models using the generated β₁ and with a chosen θᵢ (e.g., set to the T-pose).

In accordance with an embodiment, at operation 306 of the method 300, skeleton features for each of the generated SMPL models are computed. For example, skeleton features fᵢ may be computed for each pᵢ as distances between the following pairs of joints: (right hip, right knee), (right knee, right ankle), (head, right ankle), (head, right wrist), (right shoulder, right elbow), (right elbow, right wrist). Other definitions of skeleton features may be used.

As an alternative to (or in addition to) operations 302, 304, and 306, a target skeleton is received or accessed at operation 308. The target skeleton might be a custom character which is not a SMPL model skeleton. At operation 310, skeleton features are computed for the target skeleton. In accordance with an embodiment, the similar skeleton features are computed for the target skeleton as are computed for each of the generated SMPL models (e.g., within operation 306).

At operation 312, a set of betas and a scale value is determined. The set of betas and the scale value corresponds to a plausible single SMPL model which optimally approximates the target skeleton. The set of betas multiplied by the scale value and used in equation 1 may generate the SMPL model. In accordance with an embodiment, the set of betas (and scale) are determined with machine learning by training a model to infer beta values (and a scale) from the plurality of SMPL models processed in operations 302, 304, and 306 wherein the inferred beta values correspond with an SMPL model skeleton that most closely match the computed skeleton features for the target skeleton (determined in operation 310), wherein the machine learning model compares the computed skeleton features for the target skeleton to the computed skeleton features for each of the generated SMPL models (determined in operation 306).

In accordance with an embodiment, as part of operation 312 to determine the set of betas (and scale), given the plurality of SMPL models from operation 302 (e.g., a 20k sample), including their computed skeleton features from operation 306, and the features of the user skeleton f computed in operation 310, the system implements a kernel density estimator for the shape parameters (the desired set of betas including scale) of the desired SMPL model approximating the user supplied skeleton:

$$\hat{β} = {\sum }_{i} \frac{{\tilde{β}}_{f} {w}_{i}}{{Σ}_{j} {w}_{j}} , where {w}_{i} = k ( ( f - {\tilde{f}}_{i} ) / h ) \qquad ( Eq . 3 )$$

Here k may be a kernel (e.g., a window function such as a Gaussian kernel) with a predetermined width. The theory behind this implementation is that in general, for each received skeleton in operation 308, characterized e.g. by its bone lengths, there exist multiple equally plausible β's. Therefore, a point solution of the inverse problem is likely to be degenerate. To resolve this, in an example embodiment, the general solution may be formed in probabilistic Bayesian terms, based on a probability p(\tilde{β}, f), the joint generative distribution of skeleton shape and features may be:

\hat{β}=∫\tilde{β}p(\tilde{β}|f)d\tilde{β} (Eq. 4)

In accordance with an embodiment, the decomposition p(\tilde{β}, f)=p(f|\tilde{β})p(\tilde{β}) may be used to arrive at (eq. 5):

$$\hat{β} = \int \frac{\tilde{β} p ( f \vert \tilde{β} ) p ( \tilde{β} ) d \tilde{β}}{\int p ( f \vert \hat{β} ) p ( \tilde{β} ) d \hat{β}}$$

In accordance with an embodiment, since the probability joint distribution p(\tilde{β}, f) is unknown, it may be approximated using a combination of kernel density estimation and Monte Carlo sampling. Assuming conservative uniform prior for p(\tilde{β}), the β may be sampled as described above and a kernel density estimator (e.g.,

$$p ( f \vert \tilde{β} ) \approx \frac{1}{h N} {Σ}_{i} k ( \frac{f - {f}_{i}}{h} ) )$$

may be used. Using this in eq. (5) together with Monte Carlo sampling from p(\tilde{β}), results in eq. (3).

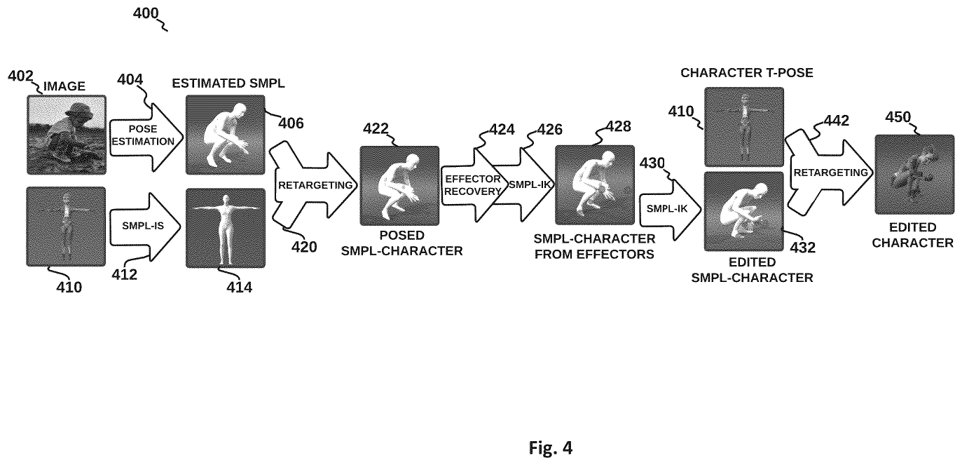

In example embodiments, FIG. 4 is a diagram of an artistic workflow pipeline 400 which includes the morphology-aware inverse kinematics SMPL-IK system 100. The pipeline 400 includes SMPL-IK (426, 430), and SMPL-IS (412) and effector recovery algorithms to connect a user-defined custom character 410 and state-of-the-art AI pose authoring tools to a computer vision backbone to refine a 3D scene acquired from a picture 402. In accordance with an embodiment, and shown in FIG. 4, an output 406 of monocular pose estimation algorithm 404 may be used to initialize the editing of a multi-person 3D scene. The monocular pose estimation algorithm 404 may operate on a monocular RGB image 402. A few methods exist for pose estimation from RGB inputs (e.g., including ROMP and HybrIK). The pose estimation algorithm 404 may predict shape (SMPL β-parameters), 3D joint rotations (SMPL θ-parameters), and 3D root joint location for each human instance in the image 402. While the pose estimation algorithm 404 may output a pose 406 in the standardized SMPL space, whereas users may wish to retarget (repurpose) the pose towards their own custom character.

In accordance with an embodiment, SMPL-IS 412 is used on a custom character 410 to estimate a SMPL character 414 that best approximates the custom character. Procedural retargeting is used to retarget 420 the initial pose estimation result 406 onto the SMPL character 414 obtained via SMPL-IS from the user supplied character 410. The retargeting 420 generates a posed SMPL character 422. Then effector recovery is used 424 to determine an optimal set of effectors to use with the SMPL character 428. SMPL-IK is then used 430 to edit the SMPL character 428 to create an edited SMPL character 432. The pose 432 edited by the animator is then retargeted 442 back on the user character 410 to create a final edited character 450 in the edited pose with the custom character 410.

In both applications of retargeting 420 442 in the pipeline 400, SMPL-IS makes the job of procedural retargeting easier. First, it aligns the topology of the user character with the SMPL space. Second, the SMPL character derived through SMPL-IS is a close approximation of the user character, therefore, the retargeting from SMPL space back to the user character space is simpler. Retargeting refers to the task of transferring a pose of a first character to a target character, wherein the first character and target character have a different morphology (e.g., bone lengths) and possibly a different topology (e.g., number of joints, connectivity, etc.). Retargeting may be applied between skeletons of different morphologies and even topologies. For example, retargeting may be used to transfer a pose of a human captured using Motion Capture (MoCap) technology onto a custom humanoid character.

Effector Recovery:

Pose estimation output (e.g., operation 404 in the pipeline 400) may provide a full pose description of each human in a scene, wherein the description includes a large amount of data for each human (e.g., 10 β-parameters, 24 3D joint angles and 3D root joint location for each human characterized with a SMPL model). Accordingly, the full description may be dense and rigid for the purpose of refining a pose or authoring a new pose since there can be many effectors (e.g., there may be at least one per joint). For example, a pose editing method constrained by this information (e.g., with a large number of effectors) may be tedious and inefficient. Learned IK tools (e.g., including SMPL-IK) allow for pose authoring using very sparse constraints (e.g. using 5-6 effectors). Therefore, in example embodiments, the system uses an Effector Recovery method to extract only a limited number of effectors from the full pose information provided by the pose estimation algorithm to create an editable initial pose based on sparse constraints that is better suited to the SMPL-IK system 100.

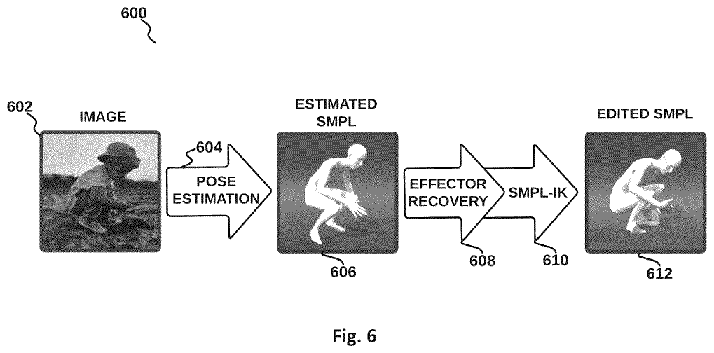

The effector recovery method may be an iterative process that begins with a full pose character and an empty set of effectors (e.g., the iteration may begin with zero effectors). The full pose character may be provided by a computer vision backbone from a 2D image as shown in FIG. 4 and FIG. 6. At the beginning of an iteration loop, an additional effector is added to a set of effectors output from a previous iteration loop. The modified candidate effector configuration (e.g., which includes the added effector) is run through SMPL-IK system 100 to obtain a pose reconstructed from this configuration. A new effector configuration is determined by retaining a candidate effector set that minimizes a reconstruction error (e.g., reduces or minimizes an L2 joint error) in the character space between the reconstructed pose and the initial pose. This process is repeated until either a maximum number of allowed effectors is reached, or the reconstruction error falls below a threshold. This greedy algorithm produces a minimalistic set of effectors most useful in retaining the initial pose, and allowing for flexible pose editing at the same time via SMPL-IK.

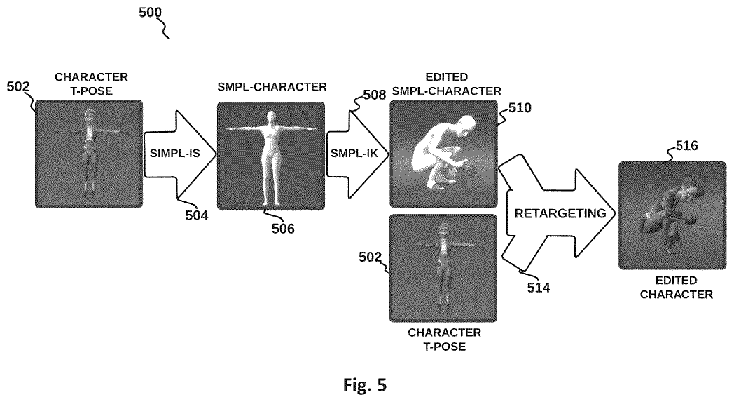

In accordance with an embodiment, FIG. 5 is a flowchart of a pipeline 500 for pose authoring with a custom humanoid character via SMPL-IK (e.g., using the system shown in FIG. 1) and SMPL-IS (e.g., using the method shown in FIG. 3). As part of the pipeline 500, SMPL-IS is applied 504 to a custom character 502 (e.g., in a T-pose) to generate a SMPL character 506 which best approximates the custom character. SMPL-IK can then be used 508 on the SMPL character 506 to generate an edited SMPL character 510. Retargeting can then be applied 514 to the custom character 502 to retarget it onto the edited SMPL character 510 to generate the final edited character 516 with the custom character applied.

In accordance with an embodiment, FIG. 6 is a flowchart of a pipeline 600 for 2D image labeling with an accurate 3D pose. As part of the pipeline, pose estimation is applied 604 to a 2D image 602 (e.g., a monocular image) to generate an estimated SMPL character 606 in a pose represented in the image. Effector recovery is applied 608 to the estimated SMPL character 606 to determine an optimal minimum set of effectors for the character. SMPL-IK can then be applied 610 to edit the SMPL character to quickly modify the pose to more accurately match the image. The 2D image 602 can then be accurately labeled using the accurate 3D pose 612. While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

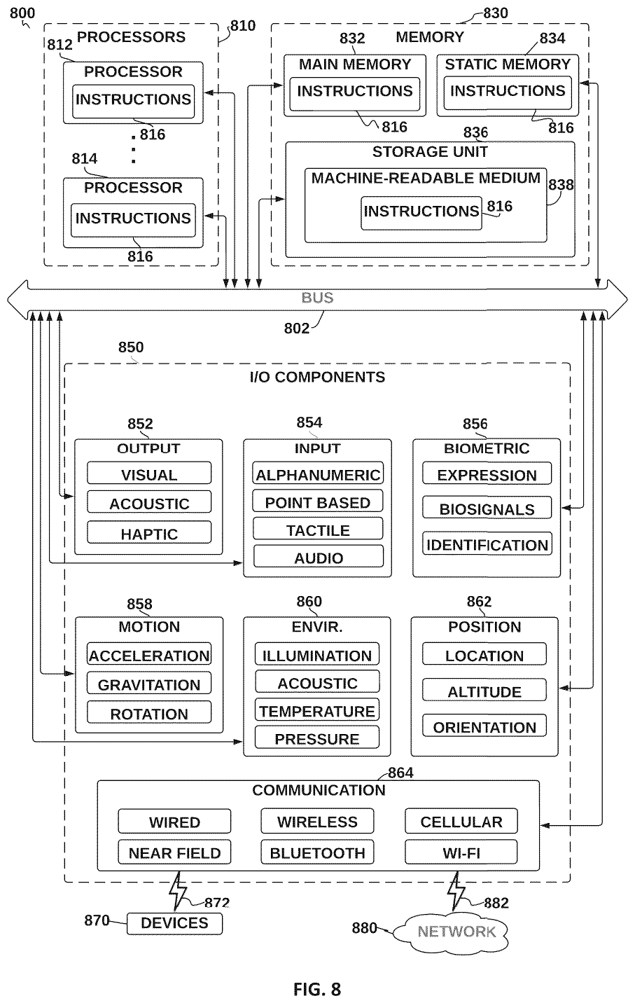

FIG. 7 is a block diagram 700 illustrating an example software architecture 702, which may be used in conjunction with various hardware architectures herein described to provide a gaming engine and/or components of the SMPL-IK system 100. FIG. 7 is a non-limiting example of a software architecture and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 having associated executable instructions 708. The executable instructions 708 represent the executable instructions of the software architecture 702, including implementation of the methods, modules and so forth described herein. The hardware layer 704 also includes memory/storage 710, which also includes the executable instructions 708. The hardware layer 704 may also comprise other hardware 712.

In the example architecture of FIG. 7, the software architecture 702 may be conceptualized as a stack of layers where each layer provides particular functionality. For example, the software architecture 702 may include layers such as an operating system 714, libraries 716, frameworks or middleware 718, applications 720 and a presentation layer 744. Operationally, the applications 720 and/or other components within the layers may invoke application programming interface (API) calls 724 through the software stack and receive a response as messages 726. The layers illustrated are representative in nature and not all software architectures have all layers. For example, some mobile or special purpose operating systems may not provide the frameworks/middleware 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be used by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 816 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) provide a higher-level common infrastructure that may be used by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742 (e.g., including the SMPL-IK module 743). Examples of representative built-in applications 740 may include, but are not limited to, a contacts application, a browser application, a book reader application, a location application, a media application, a messaging application, and/or a game application. Third-party applications 742 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 742 may invoke the API calls 724 provided by the mobile operating system such as operating system 714 to facilitate functionality described herein.

The applications 720 may use built-in operating system functions (e.g., kernel 728, services 730 and/or drivers 732), libraries 716, or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures use virtual machines. In the example of FIG. 7, this is illustrated by a virtual machine 748. The virtual machine 748 creates a software environment where applications/modules can execute as if they were executing on a hardware machine (such as the machine 800 of FIG. 8, for example). The virtual machine 748 is hosted by a host operating system (e.g., operating system 714) and typically, although not always, has a virtual machine monitor 746, which manages the operation of the virtual machine 748 as well as the interface with the host operating system (i.e., operating system 714). A software architecture executes within the virtual machine 748 such as an operating system (OS) 750, libraries 752, frameworks 754, applications 756, and/or a presentation layer 758. These layers of software architecture executing within the virtual machine 748 can be the same as corresponding layers previously described or may be different.

FIG. 8 is a block diagram illustrating components of a machine 800, according to some example embodiments, configured to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. As such, the instructions 816 may be used to implement modules or components described herein. The instructions transform the general, non-programmed machine into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines that individually or jointly execute the instructions 816 to perform any one or more of the methodologies discussed herein.

The machine 800 may include processors 810, memory 830, and input/output (I/O) components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that may execute the instructions 816. The term “processor” is intended to include multi-core processor that may comprise two or more independent processors (sometimes referred to as “cores”) that may execute instructions contemporaneously. Although FIG. 8 shows multiple processors, the machine 800 may include a single processor with a single core, a single processor with multiple cores (e.g., a multi-core processor), multiple processors with a single core, multiple processors with multiples cores, or any combination thereof.

The memory/storage 830 may include a memory, such as a main memory 832, a static memory 834, or other memory, and a storage unit 836, both accessible to the processors 810 such as via the bus 802. The storage unit 836 and memory 832, 834 store the instructions 816 embodying any one or more of the methodologies or functions described herein. The instructions 816 may also reside, completely or partially, within the memory 832, 834, within the storage unit 836, within at least one of the processors 810 (e.g., within the processor's cache memory), or any suitable combination thereof, during execution thereof by the machine 800. Accordingly, the memory 832, 834, the storage unit 836, and the memory of processors 810 are examples of machine-readable media 838.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific input/output (I/O) components 850 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 850 may include many other components that are not shown in FIG. 8. The input/output (I/O) components 850 are grouped according to functionality merely for simplifying the following discussion and the grouping is in no way limiting. In various example embodiments, the input/output (I/O) components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 862, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance.

Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

The term ‘content’ used throughout the description herein should be understood to include all forms of media content items, including images, videos, audio, text, 3D models (e.g., including textures, materials, meshes, and more), animations, vector graphics, and the like.

The term ‘game’ used throughout the description herein should be understood to include video games and applications that execute and present video games on a device, and applications that execute and present simulations on a device. The term ‘game’ should also be understood to include programming code (either source code or executable binary code) which is used to create and execute the game on a device.

The term ‘environment’ used throughout the description herein should be understood to include 2D digital environments (e.g., 2D video game environments, 2D simulation environments, 2D content creation environments, and the like), 3D digital environments (e.g., 3D game environments, 3D simulation environments, 3D content creation environments, virtual reality environments, and the like), and augmented reality environments that include both a digital (e.g., virtual) component and a real-world component.

The term ‘digital object’, used throughout the description herein is understood to include any object of digital nature, digital structure or digital element within an environment. A digital object can represent (e.g., in a corresponding data structure) almost anything within the environment; including 3D models (e.g., characters, weapons, scene elements (e.g., buildings, trees, cars, treasures, and the like)) with 3D model textures, backgrounds (e.g., terrain, sky, and the like), lights, cameras, effects (e.g., sound and visual), animation, and more. The term ‘digital object’ may also be understood to include linked groups of individual digital objects. A digital object is associated with data that describes properties and behavior for the object.

The terms ‘asset’, ‘game asset’, and ‘digital asset’, used throughout the description herein are understood to include any data that can be used to describe a digital object or can be used to describe an aspect of a digital project (e.g., including: a game, a film, a software application). For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more digital objects within a game at runtime (e.g., during execution of the game).

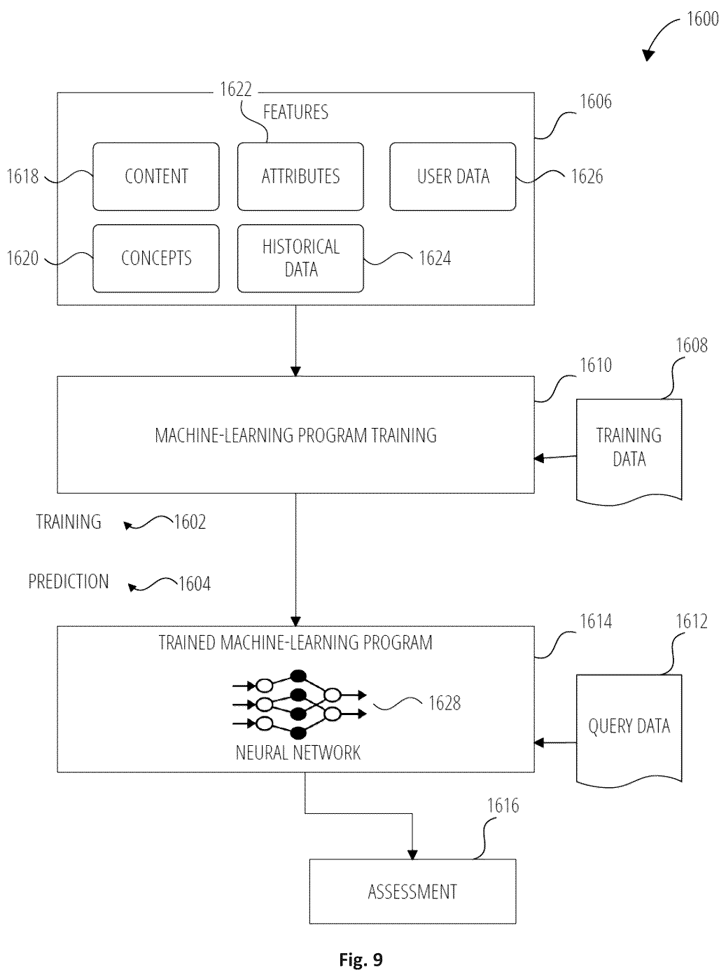

FIG. 9 is a block diagram showing a machine-learning program 1600 according to some examples. The machine-learning programs 1600, also referred to as machine-learning algorithms or tools, are used to train machine learning models, which can be used as part of modules and components of an application interaction system 200.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1608 in order to make data-driven predictions or decisions expressed as outputs or assessments (e.g., assessment 1616). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1600 supports two types of phases, namely a training phase 1602 and prediction phase 1604. In a training phase 1602, supervised learning, unsupervised or reinforcement learning may be used. For example, the machine-learning program 1600 (1) receives features 1606 (e.g., as structured or labeled data in supervised learning) and/or (2) identifies features 1606 (e.g., unstructured or unlabeled data for unsupervised learning) in training data 1608. In a prediction phase 204, the machine-learning program 1600 uses the features 1606 for analyzing query data 1612 to generate outcomes or predictions, as examples of an assessment 1616.

In the training phase 1602, feature engineering is used to identify features 1606 and may include identifying informative, discriminating, and independent features for the effective operation of the machine-learning program 1600 in pattern recognition, classification, and regression. In some examples, the training data 1608 includes labeled data, which is known data for pre-identified features 1606 and one or more outcomes. Each of the features 1606 may be a variable or attribute, such as individual measurable property of a process, article, system, or phenomenon represented by a data set (e.g., the training data 1608). Features 1606 may also be of different types, such as numeric features, strings, and graphs, and may include one or more of content 1618, concepts 1620, attributes 1622, historical data 1624 and/or user data 1626, merely for example.

In training phases 1602, the machine-learning program 1600 uses the training data 1608 to find correlations among the features 1606 that affect a predicted outcome or assessment 1616.

With the training data 1608 and the identified features 1606, the machine-learning program 1600 is trained during the training phase 1602 at machine-learning program training 1610. The machine-learning program 1600 appraises values of the features 1606 as they correlate to the training data 1608. The result of the training is the trained machine-learning program 1614 (e.g., a trained or learned model).

Further, the training phases 1602 may involve machine learning, in which the training data 1608 is structured (e.g., labeled during preprocessing operations), and the trained machine-learning program 1614 implements a relatively simple neural network 1628 (or one of other machine learning models, as described herein) capable of performing, for example, classification and clustering operations. In other examples, the training phase 1602 may involve deep learning, in which the training data 1608 is unstructured, and the trained machine-learning program 1614 implements a deep neural network 1628 that is able to perform both feature extraction and classification/clustering operations.

A neural network 1628 generated during the training phase 1602, and implemented within the trained machine-learning program 1614, may include a hierarchical (e.g., layered) organization of neurons. For example, neurons (or nodes) may be arranged hierarchically into a number of layers, including an input layer, an output layer, and multiple hidden layers. The layers within the neural network 1628 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1628 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), merely for example.

During prediction phases 1604 the trained machine-learning program 1614 is used to perform an assessment. Query data 1612 is provided as an input to the trained machine-learning program 1614, and the trained machine-learning program 1614 generates the assessment 1616 as output, responsive to receipt of the query data 1612.

### Example: Storing a Trained Model With ONNX File Format

A trained neural network model (e.g., a trained machine learning program 1614 using a neural network 1628) may be stored in a computational graph format, according to some examples. An example computational graph format is the Open Neural Network Exchange (ONNX) file format, an open, flexible standard for storing models which allows reusing models across deep learning platforms/tools, and deploying models in the cloud (e.g., via ONNX runtime).

In some examples, the ONNX file format corresponds to a computational graph in the form of a directed graph whose nodes (or layers) correspond to operators and whose edges correspond to tensors. In some examples, the operators (or operations) take the incoming tensors as inputs, and output result tensors, which are in turn used as inputs by their children.

In some examples, trained neural network models (e.g., examples of trained machine learning programs 1614) developed and trained using frameworks such as TensorFlow, Keras, PyTorch, and so on can be automatically exported to the ONNX format using framework-specific export functions. For instance, PyTorch allows the use of a torch.export(trainedModel, outputFile ( . . . )) function to export a trained model ready to be run to a file using the ONNX file format. Similarly, TensorFlow and Keras allow the use of the tf2onnx library for converting trained models to the ONNX file format, while Keras also allows the use of keras2onnx for the same purpose.

In example embodiments, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents. The continuously updated and retrained artificial intelligence agents may then be applied to subsequent novel input data to generate one or more of the outputs described herein.

I/We claim:

1. A system comprising:
one or more computer processors;
one or more computer memories;
a set of instructions stored in the one or more computer memories, the set of instructions configuring the one or more computer processors to perform operations, the operations comprising:
accessing a skeleton corresponding to a user-supplied character;
computing features for the skeleton corresponding to the user-supplied character, the features including a set of effectors;
determine a set of betas and a scale value that correspond to a skinned multi-person linear (SMPL) model of the skeleton corresponding to the features; and
estimating a pose of a skeleton of a custom character using the SMPL model and the set of effectors.

2. The system of claim 1, wherein the determining of the set of betas and scale value includes using a machine learning model trained to infer the beta values and the scale value from the SMPL model.

3. The system of claim 1, wherein the inferred beta values and the scale value match computed features of the pose of the skeleton of the custom character.

4. The system of claim 1, wherein the training of the machine learning model includes using pairs of skeleton features extracted from a tuple along with corresponding supervision samples.

5. The system of claim 1, the operations further comprising accessing or generating a plurality of SMPL models having varying beta and scale values.

6. The system of claim 5, further comprising computing joint positions for each of the accessed or generated plurality of SMPL models using the varying beta and scale values.

7. The system of claim 6, further comprising computing skeleton features for each of the plurality of SMPL models and wherein the training of the machine learning model includes matching the computed skeleton features with the pose of the skeleton of the custom character.

8. The system of claim 1, further comprising using an iterative effector recovery process to generate a minimum number of effectors for inclusion in the set of effectors.

9. A method comprising:
accessing a skeleton corresponding to a user-supplied character;
computing features for the skeleton corresponding to the user-supplied character, the features including a set of effectors;
determine a set of betas and a scale value that correspond to a skinned multi-person linear (SMPL) model of the skeleton corresponding to the features; and
estimating a pose of a skeleton of a custom character using the SMPL model and the set of effectors.

10. The method of claim 9, wherein the determining of the set of betas and scale value includes using a machine learning model trained to infer the beta values and the scale value from the SMPL model.

11. The method of claim 9, wherein the inferred beta values and the scale value match computed features of the pose of the skeleton of the custom character.

12. The method of claim 9, wherein the training of the machine learning model includes using pairs of skeleton features extracted from a tuple along with corresponding supervision samples.

13. The method of claim 9, further comprising accessing or generating a plurality of SMPL models having varying beta and scale values.

14. The method of claim 13, further comprising computing joint positions for each of the accessed or generated plurality of SMPL models using the varying beta and scale values.

15. The method of claim 14, further comprising computing skeleton features for each of the plurality of SMPL models and wherein the training of the machine learning model includes matching the computed skeleton features with the pose of the skeleton of the custom character.

16. The method of claim 8, further comprising using an iterative effector recovery process to generate a minimum number of effectors for inclusion in the set of effectors.

17. A non-transitory computer-readable storage medium storing a set of instructions that, when executed by one or more computer processors, causes the one or more computer processors to perform operations, the operations comprising:
accessing a skeleton corresponding to a user-supplied character;
computing features for the skeleton corresponding to the user-supplied character, the features including a set of effectors;
determine a set of betas and a scale value that correspond to a skinned multi-person linear (SMPL) model of the skeleton corresponding to the features; and
estimating a pose of a skeleton of a custom character using the SMPL model and the set of effectors.

18. The non-transitory computer-readable storage medium of claim 17, wherein the determining of the set of betas and scale value includes using a machine learning model trained to infer the beta values and the scale value from the SMPL model.

19. The non-transitory computer-readable storage medium of claim 17, wherein the inferred beta values and the scale value match computed features of the pose of the skeleton of the custom character.

20. The non-transitory computer-readable storage medium of claim 17, wherein the training of the machine learning model includes using pairs of skeleton features extracted from a tuple along with corresponding supervision samples.
